(19) United States
(12) Patent Application Publication
(10) Pub. No.: US 2003/0114540 A1
(43) Pub. Date: Jun. 19, 2003

(54) Method for producing sol-gel compositions with a reduced solvent content and improved storage properties, and the use thereof

(76) Inventor: Michael Mager, Leverkusen (DE)

Correspondence Address: BAYER POLYMERS LLC, 100 BAYER ROAD, PITTSBURGH, PA, 15205, US

(21) Appl. No.: 10/312,196

(22) PCT Filed: Jun. 18, 2001
(86) PCT No.: PCT/EP01/06835

(30) Foreign Application Priority Data
Jun. 29, 2000 (DE) 100 31 764.2

(51) Int. Cl. C09K 3/00

(52) U.S. Cl. 516/99

(57) ABSTRACT

The present invention relates to a process for producing inorganic or organic-inorganic (hybrid) materials by hydrolysis and condensation of mono- or low molecular alkoxides and their use for coating surfaces and modifying organic polymers.

The present invention relates to a process for producing inorganic or organic-inorganic (hybrid) materials by hydrolysis and condensation of mono- or low molecular alkoxides and their use for coating surfaces and modifying organic polymers.

Alkoxides, generally (organo-)silicon alkoxides are conventionally used in sol-gel reactions and are reacted in a solvent with water in the presence of a catalyst to produce suitable coating formulations. After a certain reaction time, the reaction solution is applied to the desired surface and after evaporation of the volatile components is finally cured by heat or radiation. The usually highly crosslinked sol-gel coatings obtained in this way are generally transparent, outstandingly resistant to solvents and chemicals and wear-resistant.

A fundamental problem of sol-gel reactive solutions is that the quantity of solvent can only be reduced to a very limited extent and therefore the solids content can be increased without the pot life becoming too short. This applies in particular to systems in which, during production, the alcohols conventionally used as solvents strongly influence the reaction kinetics of the condensation and transesterification of the alkoxides used. Owing to the alcohols liberated during condensation of alkoxides to siloxanes, the solvent content additionally increases, as during condensation of, for example, tetraethyl orthosilicate 72 wt. % of ethanol are theoretically liberated.

Alkoxides and silanols based on cyclic carbosiloxanes are particularly suitable for producing organic-inorganic hybrid materials, as described for example in WO 94/06807, EP-A-0 787 734 and EP-A-0 947 520. A substantial disadvantage of the sol-gel solutions described there, however, is their high solvent content and the limited pot life. Solvent contents greater than 70 wt. % are no longer acceptable in the paint industry on ecological grounds, in particular in sectors where the disposal of the solvent cannot be handled correctly.

WO 98/52992 describes oligomers of the above-mentioned cyclic carbosiloxanes which can be co-condensated with alkoxides and/or nanoparticles in a solvent in the presence of a catalyst and water. The production of such condensates corresponds to that described, for example, in DE-A-196 03 242 and in WO 94/06897, wherein only low solids contents could be achieved.

The object of the present invention was therefore to provide sol-gel compositions based on cyclic carbosiloxanes with a solvent content of less than 60 wt. % and a pot life of at least 7 days.

The present invention relates to a process for producing sol-gel compositions from cyclic carbosiloxanes and (organo-)metallic alkoxides with a solvent content less than 60 wt. % and a stability in storage of at least 7 days, characterised in that the process steps

A) reaction of a mixture containing cyclic carbosiloxanes and (organo-)metallic alkoxides with water in the presence of a catalyst and optionally additional solvent, and

B) partial or complete removal of the alcohols liberated during hydrolysis and condensation and of the optionally added solvent

are carried out in succession.

In a preferred embodiment of the process according to the invention, the sol-gel compositions are produced by the successive process steps

A)

a) reaction of the cyclic carbosiloxanes with water in the presence of a catalyst and optionally additional solvent,

then

b) addition of the (organo-)metallic alkoxide, and

B) partial or complete removal of the alcohols liberated during hydrolysis and condensation and of the optionally added solvent.

The sol-gel compositions produced according to the invention preferably contain less than 50 wt. %, particularly preferably less than 40 wt. % of solvent. They are stable in storage for at least 7 days (i.e. the sol-gel compositions have not gelled), but are condensed to the extent that curing after application to a surface can take, e.g., place without further addition of components (for example water, catalysts).

Cyclic carbosiloxanes in the context of the invention are those of Formula (I)

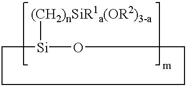

in which

R¹ represents C₁ to C₄ alkyl,

R² represents hydrogen and/or C₁ to C₄ alkyl

a is the integer 0, 1 or 2,

n is the integer 2 to 10 and

m is the integer 3 to 5.

Oligomeric cyclic carbosiloxanes of Formula (I) and their production are described in WO 98/52992 and can be used as well in the procedure described.

According to the invention, (organo-)silicon alkoxides of Formula (II)

R³_{b}Si(OR⁴)_{4-b} (II),

are preferred as (organo-)metallic alkoxides, in which

R³ represents a C₁ to C₄ alkyl or C₆ to C₁₀ aryl radical

R⁴ represents a C₁ to C₄ alkyl radical and

b is an integer 0, 1 or 2.

Tetraethoxysilane is particularly preferably used as silicon alkoxide of Formula (II).

Water in the molar ratio 1:2 to 3:1, preferably 3:1 to 1.5:1, is used for hydrolysis of the alkoxy groups Si—O—R.

1 to 90, preferably 25 to 60 wt. % of the cyclic carbosiloxane and 99 to 20, preferably 75 to 40 wt. % of the (organo-)metallic alkoxide are used to produce the sol-gel compositions according to the invention.

Aqueous inorganic or organic acids or bases such as formic acid, p-toluene sulphonic acid, hydrochloric acid or sodium and potassium hydroxide or organic metal compounds are mentioned as examples of catalysts. The catalyst is preferably an acid, particularly preferably para-toluene sulphonic acid.

Between 0.01 wt. % and 5 wt. % are preferably added as catalyst based on the reaction mixture.

Suitable solvents are those with a boiling point higher than 80° C., for example 1-butanol, 1-pentanol, 2-pentanol, 1-methoxy-2-propanol or diacetone alcohol.

The alcohols liberated during hydrolysis and condensation and the optionally added solvent are removed by distillation, preferably under normal pressure.

The process according to the invention for producing sol-gel compositions also allows the substitution of protic solvents, such as alcohols, by aprotic solvents such as ketones, esters or ethers. As aprotic solvents do not react with isocyanates for example, mixtures of sol-gel compositions produced in this way can be obtained with isocyanate group-containing and OH group-containing polymers without the blocked isocyanates described in WO 98/38251 having to be used to produce such organic-inorganic hybrid materials. Inorganically modified polyurethanes which can be used as coatings with improved wear resistance can be obtained from these mixtures.

Additives such as flow-control agents or wetting agents can be added to the sol-gel compositions produced according to the invention before, during or after production in order to improve, for example, the appearance of the film. The sol-gel coatings can be coloured by adding organic or inorganic dyes (soluble) or pigments (insoluble). The addition of UV protective agents primarily serves to protect the coated substrate, for example plastics material.

By adding nanoparticles to the sol-gel compositions produced according to the invention, the mechanical properties, for example, of the coatings which can be produced therefrom can also be improved. Examples of suitable preparations of nanoparticles are dispersions of SiO₂, Al₂O₃— or TiO₂— containing particles in water or solvents. In order to be able to produce transparent coatings, the particle size of the nanoparticles is preferably less than 100 nm, particularly preferably less than 50 nm (determined by ultracentrifuging).

The invention also relates to the sol-gel compositions produced according to the invention for producing coatings for use, for example on glass, ceramics, metals and plastics materials.

Application can be by any common painting technique such as spraying, dipping, centrifuging, casting, flow coating or painting.

After application, curing can take place at ambient temperature or can be forced at higher temperatures.

The invention also relates to the use of the sol-gel compositions produced according to the invention for inorganic modification of organic polymers. Examples of organic polymers are polyethers, polyesters, polyvinyl alcohols, polycarbonates or copolymers and mixtures (blends) thereof. Hydroxyl group-containing organic polymers (such as polyols) can be modified particularly well with the sol-gel compositions as compatibility therewith is generally very good.

Modification of epoxides or polyurethanes by the sol-gel compositions produced according to the invention leads, for example, to coatings with clearly improved wear resistance.

### EXAMPLES

D4-diethoxide oligomer, an oligomer mixture of partially condensed cyclo-{SiO[(CH₂)₂SiCH₃(OEt)₂]}₄ was produced as described in WO 98/52992. Tetraethyl orthosilicate (TEOS) and the solvents used were used without further purification. A 0.1 N aqueous solution of p-toluene sulphonic acid (p-TSS solution) was used as a catalyst for condensation and hydrolysis. Levasil® 200S/30 (Bayer AG, Leverkusen) is a 30% colloidal dispersion of amorphous SiO₂ nanoparticles (primary particle size approximately 15 nm) which is cationically stabilised at pH=3.8.

The calculated solids contents given are based on the solids theoretically remaining after complete hydrolysis and condensation of the alkoxides contained in the sol-gel reaction solution and complete removal of the volatile components.

The solids contents were determined experimentally by weighing in 1 g of the sol-gel reaction solution into a crystallisation basin (diameter: 7.5 cm) and evaporating the volatile components at 130° C. in a circulating air oven for 1 hour.

The stability in storage of the sol-gel compositions produced according to the invention was tested (gelling) by allowing them to stand at ambient temperature and at 50° C. in a well-sealed test tube for at least 14 days.

All percentages are based on the weight.

### Example 1

### Sol-gel Composition (52 %) in 1-methoxy-2-propanol

8.2 g p-TSS solution were added to 25 g D4-diethoxide oligomer in 50 g 1-methoxy-2-propanol while stirring. After stirring for 30 minutes at ambient temperature 47.2 g TEOS were added. The reaction mixture was then heated for 1 hour to 50° C. (internal thermometer). Finally, the temperature was increased (maximum bath temperature 110° C.) until 40.3 g of volatile constituents with a boiling temperature <90° C. (primarily the ethanol formed) could be distilled off. After cooling, the sol-gel composition was obtained as a low viscosity, clear liquid.

Experimental solids content: 52%

Stability in storage (ambient temperature): 41 days

Stability in storage (50° C.): 8 days.

### Example 2

### Sol-gel Composition (73%) in 1-methoxy-2-propanol

8.2 g p-TSS solution were added to 25 g D4-diethoxide oligomer in 50 g 1-methoxy-2-propanol while stirring. After stirring for 30 minutes at ambient temperature 47.2 g TEOS were added. The reaction mixture was then heated for 1 hour to 50° C. (internal thermometer). Finally, the temperature was initially increased such that, as in Example 1, 42.9 g of volatile constituents with a boiling temperature <90° C. (primarily the ethanol formed) could be distilled off. The temperature was then increased further (maximum bath temperature 130° C.), so a further 15.3 g of volatile constituents with a boiling temperature <100° C. could be condensed off. After cooling, the sol-gel composition was obtained as a viscous, clear liquid.

Experimental solids content: 73%

Stability in storage (ambient temperature): 13 days

Stability in storage (50° C.): 4 days.

### Example 3

### Sol-gel Composition (57%) in 1-butanol

The process was carried out as described in Example 1, using 1-butanol instead of 1-methoxy-2-propanol as solvent. Distillation produced 42.7 g of volatile constituents.

Experimental solids content: 57%

Stability in storage (ambient temperature): 31 days

Stability in storage (50° C.): 10 days.

### Example 4

### Sol-gel Composition (61%) in 1-pentanol

The process was carried out as described in Example 1, using 1-pentanol instead of 1-methoxy-2-propanol as solvent. Distillation produced 40.9 g of volatile constituents.

Experimental solids content: 61%

Stability in storage (ambient temperature): 39 days

Stability in storage (50° C.): 10 days.

### Example 5

### Sol-gel Composition (40%) in methoxypropylacetate

8.2 g p-TSS solution were added to 25 g D4-diethoxide oligomer in 50 g methoxypropylacetate while stirring. After stirring for 30 minutes at ambient temperature 47.2 g TEOS were added, and the solution became cloudy. The reaction mixture was then heated for 2 hours to 50° C. (internal thermometer) and 10 ml 2-methyl ethyl ketone were then added. After cooling to ambient temperature, filtration from slightly colourless precipitate was carried out. Finally, 35.5 g of volatile constituents with a boiling temperature <90° C. (primarily the ethanol formed) were distilled off from the clear filtrate obtained (127.1 g) at a maximum bath temperature of 110° C. After cooling, the sol-gel formulation was obtained as a low viscosity, clear liquid.

Experimental solids content: 40%

Stability in storage (ambient temperature): 15 days

Stability in storage (50° C.): 3 days.

### Example 6

### Sol-gel Composition (41%) in n-butylacetate

8.2 g p-TSS solution were added to 25 g D4-diethoxide oligomer in 50 g n-butylacetate while stirring. After stirring for 30 minutes at ambient temperature 47.2 g TEOS were added and the cloudy reaction mixture was then heated for 2 hours to 50° C. (internal thermometer). After cooling to ambient temperature, filtration from slightly colourless precipitate was carried out. Finally, 35.5 g of volatile constituents with a boiling temperature <90° C. (primarily the ethanol formed) were distilled off from the clear filtrate obtained (117.7 g) at a maximum bath temperature of 110° C. After cooling, the sol-gel composition was obtained as a low viscosity, clear liquid.

Experimental solids content: 41.5%

Stability in storage (ambient temperature): 28 days

Stability in storage (50° C.): 7 days.

### Example 7

### Sol-gel Composition (53%) in 1-methoxy-2-propanol

8.2 g p-TSS solution were added to 25 g D4-diethoxide oligomer in 50 g 1-methoxy-2-propanol while stirring. After stirring for 30 minutes at ambient temperature 47.2 g TEOS were added. The reaction mixture was then heated for 1 hour to 50° C. (internal thermometer). After adding 0.1 g NaHCO₃, the temperature was then increased (maximum bath temperature 110° C.) until 40.4 g of volatile constituents with a boiling temperature <90° C. (primarily the ethanol formed) could be distilled off. After cooling, the sol-gel composition was obtained as a low viscosity, clear liquid.

Experimental solids content: 53%

Stability in storage (ambient temperature): 8 days

Stability in storage (50° C.): 1 day.

### Example 8

### Sol-gel Composition (44%) in methoxypropylacetate

8.2 g p-TSS solution were added to 25 g D4-diethoxide oligomer in 50 g methoxypropylacetate and stirring. After stirring for 30 minutes at ambient temperature 47.2 g TEOS were added, and the solution became cloudy. The reaction mixture was then heated for 1 hour to 50° C. (internal thermometer). Finally, 40.1 g of volatile constituents with a boiling temperature <90° C. (primarily the ethanol formed) was distilled off after addition of 0.1 g NaHCO₃, at a maximum bath temperature of 110° C. After cooling, the sol-gel composition was obtained as a low viscosity, clear liquid.

Experimental solids content: 44.0%

Stability in storage (ambient temperature): 23 days

Stability in storage (50° C.): 1 day.

### Example 9

### Sol-gel Composition (50%) in 1-methoxy-2-propanol

8.1 g p-TSS solution were added to 25 g D4-diethoxide oligomer in 50 g 1-methoxy-2-propanol while stirring. After stirring for 30 minutes at ambient temperature 47.2 g TEOS were added and stirring was continued for 30 minutes. A further 2.1 g p-TSS solution were then added and the reaction mixture was stirred for 80 minutes at ambient temperature and then heated for 1 hour to 50° C. (internal thermometer). Subsequently, 45.8 g of volatile constituents with a boiling temperature <90° C. (primarily the ethanol formed) were distilled off at a maximum bath temperature of 110° C. After cooling, 83.9 g of the sol-gel composition were obtained as a low viscosity, clear liquid.

Experimental solids content: 50.0%

Stability in storage (ambient temperature): 7 days.

### Example 10

### Sol-gel Composition (55%) in 1-methoxy-2-propanol with SiO₂-nanoparticles

8.75 g p-TSS solution were added to a mixture of 102 g of TEOS and 25 g ethanol while stirring and the reaction mixture was stirred for 1 hour. 12.5 g Levasil 200S/30 (previously adjusted to pH=2 by adding concentrated hydrochloric acid) dissolved in 6 ml ethanol were then added with vigorous stirring and the reaction mixture was stirred for 30 minutes. 77.1 g of the TEOS-nano-SiO₂ condensate obtained in this way were then mixed with 30 g D4-diethoxide oligomer and 45 g 1-methoxy-2-propanol and heated for 1 hour to 50° C. 59.9 g of volatile constituents were then distilled off at a bath temperature <110° C. After cooling, 89.4 g of the sol-gel composition were obtained as low viscosity, clear liquid.

Experimental solids content: 55%

Stability in storage (ambient temperature): 31 days

Stability in storage (50° C.): 10 days.

1. Process for producing sol-gel compositions from cyclic carbosiloxanes and (organo-)metallic alkoxides with a solvent content less than 60 wt. % and a stability in storage of at least 7 days, characterised in that the process steps
A) reacting a mixture containing cyclic carbosiloxanes and (organo-)-metallic alkoxides with water in the presence of a catalyst and optionally additional solvent, and
B) partial or complete removal of the alcohols liberated during hydrolysis and condensation and of the optionally added solvents
are carried out in succession.

2. Process according to claim 1, characterised in that the process step A) consists of
a) reacting the cyclic carbosiloxanes with water in the presence of a catalyst and optionally additional solvent, and subsequent
b) addition of the (organo-)metallic alkoxide.

3. Process according to claim 1, characterised in that the sol-gel compositions contain less than 50 wt. % of solvent.

4. Process according to claim 1, characterised in that the sol-gel compositions contain less than 40 wt. % of solvent.

5. Process according to claim 1, characterised in that cyclic carbosiloxanes of Formula (I), wherein 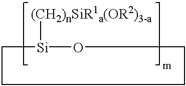
R¹ represents C₁ to C₄ alkyl,
R² represents hydrogen and/or C₁ to C₄ alkyl
a is the integer 0, 1 or 2,
n is the integer 2 to 10 and
m is the integer 3 to 5
are used.

6. Process according to claim 1, characterised in that (organo-)metallic oxides of Formula (II)
R³_{b}Si(OR⁴)_{4-b} (II),
wherein
R³ represents a C₁ to C₄ alkyl or C₆ to C₁₀ aryl radical
R⁴ represents a C₁ to C₄ alkyl radical and
b is an integer 0, 1 or 2
are used.

7. Process according to claim 4, characterised in that tetraethoxysilane is used as (organo-)metallic oxide.

8. Process according to claim 1, characterised in that aqueous inorganic or organic acids are used as catalysts.

9. Use of sol-gel formulations according to claims 1 to 6 to produce coatings.

10. Use of sol-gel formulations according to claims 1 to 6 to modify organic polymers.
